(19) United States
(12) Patent Application Publication
(10) Pub. No.: US 2012/0044268 A1
(43) Pub. Date: Feb. 23, 2012

(54) BACKLIGHT MODULE AND A LCD THEREOF

(75) Inventors: Chengming He, Shenzhen (CN); Chingyuan Yang, Shenzhen (CN)

(73) Assignee: SHENZHEN CHINA STAR OPTOELECTRONICS TECHNOLOGY CO., LTD., Shenzhen (CN)

(21) Appl. No.: 12/996,322

(22) PCT Filed: Sep. 10, 2010
(86) PCT No.: PCT/CN10/76814

§ 371 Date: Dec. 3, 2010

(30) Foreign Application Priority Data
Aug. 17, 2010 (CN) 201010260273.1

(51) Int. Cl. G09G 3/36; G09G 5/10; H05B 41/16

(52) U.S. Cl. 345/690; 315/246; 315/250; 345/102

(57) ABSTRACT

The present invention discloses a backlight module with a related liquid crystal display (LCD) which activates light emitting diodes (LEDs) by utilizing an alternate control method. The present invention utilizes two inverters to individually activate two sets of LEDs through an alternate method. During the same switching cycle period, the two sets of LEDs take turns turning on/off; that is, the two set of LEDs are in a closed state in a duty cycle of 50 percent. Since each set of the LEDs are in a closed condition in half the time during a switching cycle period, both of excess temperature produced by all of the LEDs when lightened simultaneously and thermal power generated during the lighting of the LEDs can be effectively reduced.

### BACKGROUND OF THE INVENTION

1. Field of the Invention

The present invention relates to a backlight module and a liquid crystal display (LCD) employing such a backlight module, and more particularly, to a backlight module for alternately driving lighting device and an LCD employing such a backlight module.

2. Description of Prior Art

With a rapid development of monitor types, novel and colorful monitors with high resolution, e.g., liquid crystal displays (LCDs), are indispensable components used in various electronic products such as monitors for notebook computers, personal digital assistants (PDAs), digital cameras, and projectors. The demand for the novelty and colorful monitors has increased tremendously.

A backlight module is a key component of a liquid crystal display (LCD). The purpose of the backlight module is to provide a sufficient-brightness and an even-distribution light surface to the LCD panel. Because the LCD is widely used in various electronic products such as a monitor, a notebook computer, a digital camera, and a projector, the demand for the backlight module has increased tremendously.

In addition to cold cathode fluorescent lamps (CCFLs), backlight modules also utilize light emitting diodes (LEDs) as a light source. And in recent years, LEDs have gradually become the mainstream backlight light source for LCD televisions, because they are mercury-free and thus environmentally friendly and fast responding. However, some physical properties of LEDs also influence luminous efficiency and lifespan of LEDs. Temperature is such a physical property that affects LEDs most. So, a variety of radiating materials and relevant techniques start to be applied to LED backlighting. The application of such heat dissipation techniques, undoubtedly, attempts to reduce the influence of temperature on LEDs effectively. Referring to FIG. 1, FIG. 1 shows that LEDs are activated by a traditional converter. A backlight module 1 comprises a power end 12, a plurality of LEDs 14, and a converter 16. The converter 16 comprises an inductor element L, a transistor T, a diode D, and a capacitor element C. The power end 12 supplies the converter 16 with a direct current (DC) supply voltage V_{DC}, and the transistor T switches to output a driving signal to the LEDs 14 in response to a switch signal V_{G}. The LEDs 14 produce light based on the voltage difference of the driving signal. However, the traditional LED backlight module 1 merely utilizes a single converter 16 to simultaneously activate all of the LEDs 14, which means that the converter 16 has to produce large current outputs to simultaneously activate all of the LEDs 14. But, large currents may also cause some potential problems, such as excess temperature, which not only shortens the lifespan of the LEDs 14 but also reduce the luminous efficiency of the LEDs 14.

### SUMMARY OF THE INVENTION

It is therefore an object of the present invention to provide a backlight module and an LCD employing such a module by means of an alternate driving lighting device to reduce thermal power generation.

In another aspect of the present invention, a liquid crystal display comprises a power end for generating a supply voltage, a liquid crystal display panel comprising a liquid crystal layer for displaying images, a switch signal generator for generating a first switch signal and a second switch signal, a first inverter electrically connected to the power end for generating a first driving signal based on the first switch signal, a second inverter electrically connected to the power end for generating a second driving signal based on the second switch signal, a first lighting device for producing light based on the voltage difference of the first driving signal transmitted from the first inverter, a second lighting device for producing light based on the voltage difference of the second driving signal transmitted from the second inverter. The phase difference between the first driving signal and the second driving signal is 180 degrees.

In another aspect of the present invention, a backlight module comprises a power end for generating a supply voltage, a switch signal generator for generating a first switch signal and a second switch signal, a first inverter electrically connected to the power end for generating a first driving signal based on the first switch signal, a second inverter electrically connected to the power end for generating a second driving signal based on the second switch signal, a first lighting device for producing light based on the voltage difference of the first driving signal transmitted from the first inverter, and a second lighting device for producing light based on the voltage difference of the second driving signal transmitted from the second inverter. A phase difference between the first driving signal and the second driving signal is 180 degrees.

According to the present invention, the first lighting device or the second lighting device comprises a light emitting diode (LED) or a plurality of LEDs connected in serial.

According to the present invention, the first inverter comprises a capacitor element connected in parallel to the first lighting device, an inductor element comprising a first end electrically connected to a first electrode of the power end, a diode electrically connected between a second end of the inductor element and the first lighting device, and a first transistor comprising a first end electrically connected between the inductor element and the diode and a second end electrically connected to a second electrode of the power end for conducting upon receiving the first switch signal.

According to the present invention, the second inverter comprises a capacitor element connected in parallel to the second lighting device, an inductor element comprising a first end electrically connected to a first electrode of the power end, a diode electrically connected between a second end of the inductor element and the second lighting device, a second transistor comprising a first end electrically connected between the inductor element and the diode and a second end electrically connected to a second electrode of the power end for conducting upon receiving the second switch signal.

According to the present invention, a phase inverter for inverting a switch signal generated by the switch signal generator to generate another switch signal, the two switch signals act as the first switch signal and the second switch signal.

According to the present invention, the first transistor is a PMOS transistor and the second transistor is a NMOS transistor.

Compared with the prior art, the backlight module with the related LCD in the present invention activates LEDs by using an alternate control method. If a duty cycle is set at 50 percent during a switching cycle period, the LEDs in the same string will be in a closed state in a duty cycle of 50 percent. And, all of the switching frequencies are above 1 kHz, so human eyes cannot detect variations in brightness of the LEDs. Besides, excess temperature produced by the LEDs when lightened simultaneously and thermal power generated during the lighting of the LEDs can be effectively reduced for the reason that the LEDs are in a closed condition in half or even more of the time during the switching cycle period.

These and other objects of the claimed invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows that LEDs are activated by a traditional converter.

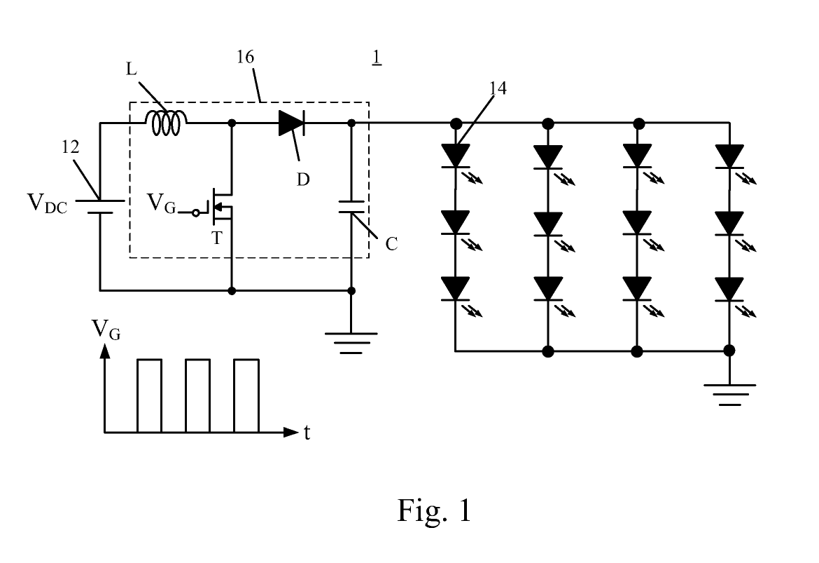

FIG. 2 is a schematic diagram of a liquid crystal display according to a first embodiment of the present invention.

FIG. 3 is a schematic diagram of an LCD according to the second embodiment of the present invention.

### DETAILED DESCRIPTION OF THE PREFERRED EMBODIMENTS

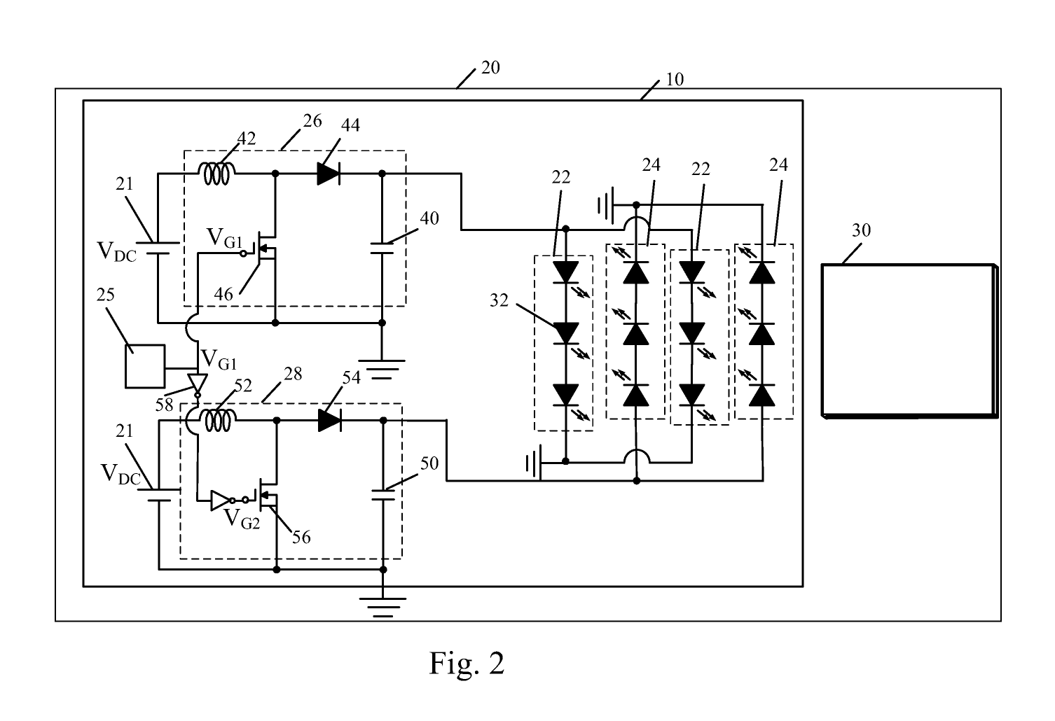

Referring to FIG. 2, FIG. 2 is a schematic diagram of a liquid crystal display (LCD) 20 according to a first embodiment of the present invention. The LCD 20 comprises a power end 21, an LCD panel 30, and a backlight module 10. The backlight module 10 produces light that the LCD panel 30 requires with a voltage provided by the power end 21. The backlight module 10 comprises a first lighting device 22, a second lighting device 24, a switch signal generator 25, a first inverter 26, and a second inverter 28. The power end 21 provides a DC supply voltage V_{DC}. The LCD panel 30 comprises a liquid crystal (LC) layer for displaying images. The first lighting device 22 and the second lighting device 24 comprise a single LED 32 or a plurality of LEDs 32 in serial. The first lighting device 22 comprises one end electrically connected to the first inverter 26 and the other end electrically connected to a voltage end (a ground end in FIG. 2) for producing light based on the voltage difference of a first driving signal emitted by the first inverter 26. The second lighting device 24 comprises one end electrically connected to the second inverter 28 and the other end electrically connected to the voltage end (the ground end in FIG. 2) for producing light based on the voltage difference of a second driving signal emitted by the second inverter 28. The switch signal generator 25 generates a switch signal V_{G1}.

Please continue referring to FIG. 2. The first inverter 26 and the second inverter 28 convert a DC voltage (12V) of the power end 21 into an alternating current (AC) high voltage. The first inverter 26 comprises a capacitor element 40, an inductor element 42, a diode 44, and a first transistor 46. The capacitor element 40 and the first lighting device 22 are connected in parallel. The inductor element 42 comprises a first end electrically connected to a first electrode of the power end 21. The diode 44 is electrically connected between a second end of the inductor element 42 and the first lighting device 22. The inductor element 42 is an charge storage element for reserving a DC supply voltage from the power end 21. The first transistor 46 comprises a first end electrically connected to the inductor element 42 and to the diode 44 and a second end electrically connected to a second electrode of the power end 21. In the present embodiment, the first transistor 46 is an N-type metal-oxide-semiconductor (MOS) transistor, having a gate connected to a first switch signal V_{G1} output by a square wave. When the first switch signal V_{G1} is at a high voltage level, the first transistor 46 conducts to make the first transistor 46, the first lighting device 22, and the diode 44 form a current loop. Meanwhile, the first lighting device 22 receives a first driving signal (i.e., a voltage level of an output end of the diode 44). The first lighting device 22 emits light because of the voltage difference of the first driving signal. When the first switch signal V_{G1} is at a low voltage level, the first transistor 46 is turned off. Meanwhile, the voltage level of the output end of the diode 44 is lowered to be identical to that of the ground end. So, the first driving signal is not transmitted to the first lighting device 22 at this time, causing that the first lighting device 22 cannot produce light due to no voltage difference of the first driving signal.

Similarly, the second inverter 28 comprises a capacitor element 50, an inductor element 52, a diode 54, and a second transistor 56. The capacitor element 50 and the second lighting device 24 are connected in parallel. The inductor element 52 comprises a first end electrically connected to the power end 21. The diode 54 is electrically connected between a second end of the inductor element 52 and the second lighting device 24. The inductor element 52 is an energy storage element for reserving a DC supply voltage from the power end 21. The second transistor 56 comprises a first end electrically connected to the inductor element 52 and to the diode 54 and a second end electrically connected to a second electrode of the power end 21. In the present embodiment, the second transistor 56 is an NMOS transistor, having a gate connected to a second switch signal V_{G2} output by a square wave. It is notified that, a phase inverter 58 inverts the first switch signal V_{G1} to form the second switch signal V_{G2}, so the phase difference between the first switch signal V_{G1} and the second switch signal V_{G2} is 180 degrees. Therefore, when the first switch signal V_{G1} is at a low voltage level, the second switch signal V_{G2} is at a high voltage level. When the second switch signal V_{G2} is at a high voltage level, the second transistor 56 conducts to make the second transistor 56, the diode 54, and the second lighting device 24 form a current loop. Meanwhile, the second lighting device 24 receives a second driving signal (i.e., a voltage level of an output end of the diode 54). The second lighting device 24 emits light because of the voltage difference of the second driving signal. When the second switch signal V_{G2} is at a low voltage level, the second transistor 56 is turned off. Meanwhile, the voltage level of the output end of the diode 54 is lowered to be identical to that of the ground end. So, the second driving signal is not transmitted to the second lighting device 24 at this time, causing that the second lighting device 24 cannot produce light due to no voltage difference of the second driving signal. The phase difference between the first switch signal V_{G1} and the second switch signal V_{G2} is 180 degrees, which causes that the phase difference between the first driving signal and the second driving signal is 180 degrees, too. In this way, the duration of lighting of the first lighting device 22 and that of the second lighting device 24 are alternate on account of the activations of the first and second driving signals; that is, either the first lighting device 22 or the second lighting device 24 is allowed to emit light at any point of time.

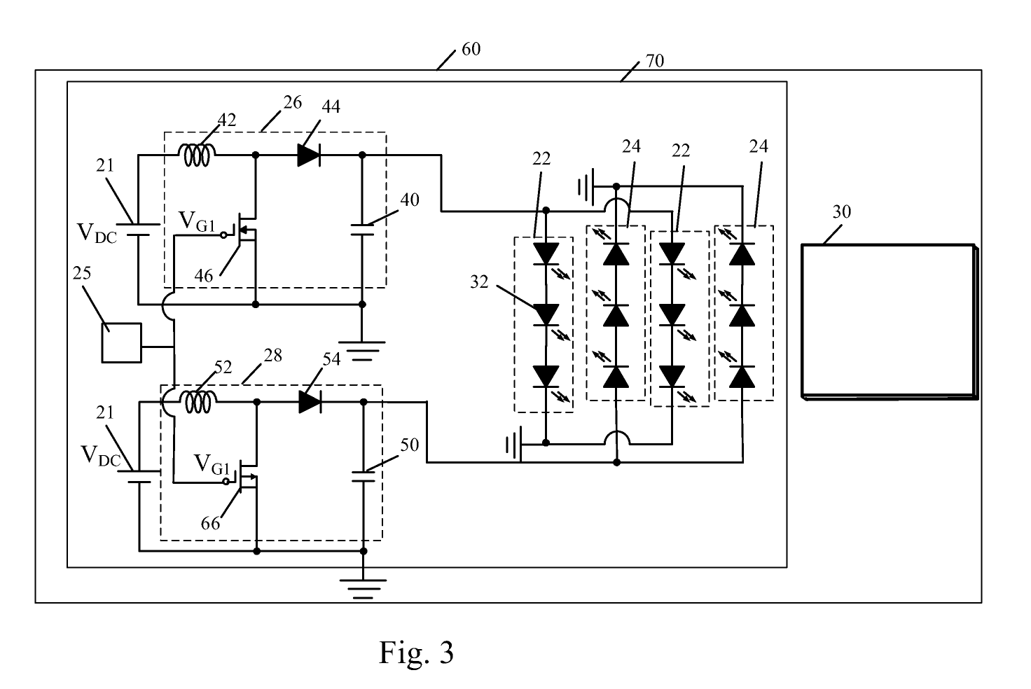

Referring to FIG. 3, FIG. 3 is a schematic diagram of an LCD 60 according to the second embodiment of the present invention. The LCD 60 comprises a power end 21, an LCD panel 30, and a backlight module 70. It is notified that, every element in FIG. 3 marked with the same code shown in FIG. 2 is given the same function. To simplify the description below, the functions of the same elements are not repeated in the following. Differing from the first embodiment in FIG. 2, in this embodiment a second transistor 66 of the second inverter 28 is a p-type metal-oxide-semiconductor (PMOS) transistor; the gate of the second transistor 66 is also controlled by the first switch signal V_{G1}; the phase inverter 58 is not needed. Opposite to the NMOS transistor, the PMOS transistor is turned on when the first switch signal V_{G1} is at a low voltage level and turned off when the first switch signal V_{G1} is at a high voltage level. In other words, even if both of the first transistor 46 and the second transistor 66 are controlled by the first switch signal V_{G1} at the same time, the second lighting device 24 will emit light upon receiving the second driving signal (i.e., the voltage level of the output end of the diode 54), and the first lighting device 22 will not receive the first driving signal and emit light (and vice versa). This is because the second transistor 66 (PMOS transistor) has opposite polarity of the threshold voltage from the first transistor 46 (NMOS transistor). In this way, the duration of lighting of the first lighting device 22 alternates with that of the second lighting device 24 owing to the activation of the first driving signal. In other words, either the first lighting device 22 or the second lighting device 24 is allowed to emit light at any point of time.

It is supposed that the one skilled in this art understand that, as long as the polarity of the turn-on voltage of the first transistor 46 is opposite to that of the second transistor 66, an object of alternately lighting of the first lighting device 22 and the second lighting device 24 can be achieved by only using the same switch signal. It is not necessary to set the first transistor 46 and the second transistor 66 as an NMOS transistor or a PMOS transistor as the above-mentioned approach does.

Both of the first switch signal and the second switch signal have a 50% duty cycle in the above embodiments. Practically, the duty cycles of the first switch signal and the second switch signal can be adjusted to 60% to 40% or to other ratios depending on actual requirements. And, the duty cycles of the first driving signal and the second driving signal are modified with those of the first switch signal and the second switch signal, too.

Consequently, the backlight module with the LCD employing such a backlight module activates the first lighting device and the second lighting device by using an alternate method. So, if both of the first switch signal and the second switch signal have a 50% duty cycle during the same switching cycle period, the first lighting device and the second lighting device will be in a closed state in a duty cycle of 50 percent, which can effectively prevent temperature from being too high when the lighting devices are lightened simultaneously and can effectively reduce thermal power generation during the lighting of the lighting devices.

Although the present invention has been explained by the embodiments shown in the drawings described above, it should be understood to the ordinary skilled person in the art that the invention is not limited to the embodiments, but rather various changes or modifications thereof are possible without departing from the spirit of the invention. Accordingly, the scope of the invention shall be determined only by the appended claims and their equivalents.

What is claimed is:

1. A liquid crystal display comprising a power end for generating a supply voltage and a liquid crystal display panel comprising a liquid crystal layer for displaying images, characterized in that the liquid crystal display further comprising:
a switch signal generator for generating a first switch signal and a second switch signal;
a first inverter electrically connected to the power end for generating a first driving signal based on the first switch signal;
a second inverter electrically connected to the power end for generating a second driving signal based on the second switch signal;
a first lighting device for producing light based on a voltage difference of the first driving signal transmitted from the first inverter; and
a second lighting device for producing light based on a voltage difference of the second driving signal transmitted from the second inverter, wherein a phase difference between the first driving signal and the second driving signal is 180 degrees.

2. The liquid crystal display of claim 1, characterized in that the first lighting device or the second lighting device comprises a light emitting diode (LED) or a plurality of LEDs connected in serial.

3. The liquid crystal display of claim 1, characterized in that the first inverter comprises:
a capacitor element connected in parallel to the first lighting device;
an inductor element comprising a first end electrically connected to a first electrode of the power end;
a diode electrically connected between a second end of the inductor element and the first lighting device; and
a first transistor comprising a first end electrically connected between the inductor element and the diode and a second end electrically connected to a second electrode of the power end for conducting upon receiving the first switch signal.

4. The liquid crystal display of claim 1, characterized in that the second inverter comprises:
a capacitor element connected in parallel to the second lighting device;
an inductor element comprising a first end electrically connected to the first electrode of the power end;
a diode electrically connected between a second end of the inductor element and the second lighting device; and
a second transistor comprising a first end electrically connected between the inductor element and the diode and a second end electrically connected to a second electrode of the power end for conducting upon receiving the second switch signal.

5. The liquid crystal display of claim 4, characterized in that the liquid crystal display further comprises a phase inverter for inverting a switch signal generated by the switch signal generator to generate another switch signal, wherein the two switch signals act as the first switch signal and the second switch signal.

6. The liquid crystal display of claim 4, characterized in that the polarity of the threshold voltage of transistor is opposite to that of the second transistor and the first and second transistors are connected to the same switch signal.

7. A backlight module comprising a power end for generating a supply voltage, characterized in that the backlight module further comprising:
a switch signal generator for generating a first switch signal and a second switch signal;
a first inverter electrically connected to the power end for generating a first driving signal based on the first switch signal;
a second inverter electrically connected to the power end for generating a second driving signal based on the second switch signal;
a first lighting device for producing light based on the voltage difference of the first driving signal transmitted from the first inverter; and
a second lighting device for producing light based on the voltage difference of the second driving signal transmitted from the second inverter, wherein a phase difference between the first driving signal and the second driving signal is 180 degrees.

8. The backlight module of claim 7, characterized in that the first lighting device or the second lighting device comprises a light emitting diode (LED) or a plurality of LEDs connected in serial.

9. The backlight module of claim 7, characterized in that the first inverter comprises:
a capacitor element connected in parallel to the first lighting device;
an inductor element comprising a first end electrically connected to a first electrode of the power end;
a diode electrically connected between a second end of the inductor element and the first lighting device; and
a first transistor comprising a first end electrically connected between the inductor element and the diode and a second end electrically connected to a second electrode of the power end for conducting upon receiving the first switch signal.

10. The backlight module of claim 7, characterized in that the second inverter comprises:
a capacitor element connected in parallel to the second lighting device;
an inductor element comprising a first end electrically connected to a first electrode of the power end;
a diode electrically connected between a second end of the inductor element and the second lighting device; and
a second transistor comprising a first end electrically connected between the inductor element and the diode and a second end electrically connected to a second electrode of the power end for conducting upon receiving the second switch signal.

11. The backlight module of claim 10, characterized in that the backlight module further comprises a phase inverter for inverting a switch signal generated by the switch signal generator to generate another switch signal, wherein the two switch signals act as the first switch signal and the second switch signal.

12. The backlight module of claim 10, characterized in that the polarity of the threshold voltage of transistor is opposite to that of the second transistor and the first and second transistors are connected to the same switch signal.
